(19) United States
(12) Patent Application Publication
(10) Pub. No.: US 2011/0242268 A1
(43) Pub. Date: Oct. 6, 2011

(54) Television Appliance

(76) Inventors: Jin Kim, San Carlos, CA (US); Teemu Suutari, Tallinn (EE)

(21) Appl. No.: 12/751,110

(22) Filed: Mar. 31, 2010

(51) Int. Cl. H04N 7/14; G06F 1/32; G06F 15/16; H04N 7/173

(52) U.S. Cl. 348/14.04; 713/323; 709/224; 725/110; 370/352; 348/E07.082

(57) ABSTRACT

A television comprising: a television screen for displaying video signals to a user; a network interface for accessing a packet-based network; processing apparatus coupled to the television screen and network interface, arranged to execute a communication client application for receiving communication events via the network interface and packet-based network; power-saving circuitry coupled to the television screen and processing apparatus, configured to switch between a higher-power mode in which the television screen is switched on and a lower-power mode in which the television screen is switched off; and a user input device communicable with the power-saving circuitry for switching between the power modes, the lower-power mode thus being a mode set in response to a manual user input from the user input device. The client continues to monitor the network interface during the low power mode in order to provide notifications and/or wake up the television.

### TECHNICAL FIELD

The present invention relates to a television having an embedded processing apparatus for conducting voice or video calls via a packet-based network.

### BACKGROUND

Some communication systems allow the user of a terminal, such as a personal computer, to conduct voice or video calls over a packet-based computer network such as the Internet. Such communication systems include voice or video over internet protocol (VoIP) systems. These systems are beneficial to the user as they are often of significantly lower cost than conventional fixed line or mobile networks. This may particularly be the case for long-distance communication. To use a VoIP system, the user installs and executes client software on their terminal. The client software sets up the VoIP connections as well as providing other functions such as registration and authentication. In addition to voice communication, the client may also set up connections for other communication media such as instant messaging (“IM”), SMS messaging, file transfer and voicemail.

One type of communication system for packet-based communication uses a peer-to-peer (“P2P”) topology. To enable access to a peer-to-peer system, a user executes P2P client software supplied by a P2P software provider on their terminal, and registers with the P2P system. When the user registers with the P2P system, the client software is provided with a digital certificate from a server. This may be referred to as a “user identity certificate” (UIC). Once the client software has been provided with the certificate, then calls or other communication connections can subsequently be set up and routed between end-users (“peers”) of the P2P system without the further use of a server in the call set-up. Instead, the client looks up the required IP addresses from information distributed amongst the P2P client software on other end-users' terminals within the P2P system. That is, the address look-up list is distributed amongst the peers themselves. Once the IP address of a callee's terminal has thus been determined, the caller's P2P client software then exchanges UIC certificates with the callee's P2P client software. The exchange of these digital certificates between users provides proof of the users' identities and that they are suitably authorised and authenticated in the P2P system. Therefore the presentation of digital certificates provides trust in the identity of the users.

It is therefore a characteristic of peer-to-peer communication that, once registered, the users can set up their own communication routes through the P2P system in at least a partially decentralized manner based on distributed address look-up and/or the exchange of one or more digital certificates, without using a server for those purposes. Further details of an example P2P system are disclosed in WO 2005/008524 and WO 2005/009019.

VoIP or other packet-based communications can also be implemented using non-P2P systems that do use centralized call set-up and/or authentication, e.g. via server.

A problem with packet-based communications is that their accessibility to users is limited. In particular, such communications are most commonly accessed using a personal computer. This has the disadvantage that the user must be sufficiently technically competent to download, install and operate the packet-based communication client software on their personal computer, which provides a barrier to the take-up. Even when the communication client is installed and executed on a personal computer, its use may be limited because personal computers are often not located in a place where the user is either familiar or comfortable with communicating. For example, a personal computer is often located in a study which for many users is not the most natural or comfortable environment for making phone calls.

Whilst packet-based communication systems can also be accessed via certain mobile devices, these generally do not have processing resources or display screens available to offer a full range of features, such as video calling.

It would therefore be desirable to make packet-based communications more accessible to users. One way to do this would be to run a packet-based communication client on a processor embedded in a familiar household media appliance like a television set. Embedded in this context means within the casing of the appliance. The ability to integrate an embedded processor into a television set is known, and indeed many modern televisions already contain a processor for performing at least some of the digital signal processing required to decode and output viewable television signals to the screen.

### SUMMARY

However, the inventors have recognised that one or more potential problems may still exist due to a conflict between the added functionality of the client application and the existing functionality of a conventional television.

Particularly, most conventional television sets have a low-power mode, typically referred to as “standby”, in which the screen is turned off. However, this may cause a problem when integrating a communication client into an appliance such as a television set, because incoming calls will be asynchronous with the current state of the television. That is to say, the calls are not chosen to be initiated by the user of the television, but instead arrive at unpredictable times at the initiation of another, remote user, and therefore may arrive when the television is in standby mode. This means the required resources may not be available to notify the user of the incoming call.

According to a first aspect of the present invention, a television comprising: a television screen for displaying video signals to a user; a network interface for accessing a packet-based network; processing apparatus coupled to the television screen and network interface, arranged to execute a communication client application for receiving communication events via the network interface and packet-based network; power-saving circuitry coupled to the television screen and processing apparatus, configured to switch between (i) a higher-power mode in which the television screen is switched on, and (ii) a lower-power mode in which the television screen is switched off; and a user input device communicable with the power-saving circuitry for switching between said modes, the lower-power mode thus being a mode set in response to a manual user input from the user input device; wherein the processing apparatus is configured so as, during the lower-power mode, to continue executing at least part of the communication client application so as to monitor the network interface and thereby detect an incoming communication event, and in response to automatically trigger the power-saving circuitry to switch to the higher-power mode so as to output a notification of the incoming communication event to the television screen prior to a manual response from said user.

For example the communication event may be an incoming call.

The processing apparatus is thus arranged to continue executing the client application without incurring the high power of the screen. It is the executing client application which then automatically wakes up the television in event of an incoming call (e.g. rather than special hardware on a board being required for the wake-up mechanism). Thus the invention advantageously saves power whilst maintaining the full functionality of the client application and so without necessarily requiring special wake-up hardware specifically to handle the incoming call functionality.

Note also that the lower-power mode of the television is a user-selected “standby” type mode that is manually set by the user, e.g. by pressing a standby button on a remote control (rather than automatically falling into a low power mode after a predetermined period of activity, as on a computer such as a PC).

For example, the user input device may comprises a remote control unit having a standby button for switching between the higher-power mode and the lower-power mode, the lower-power mode thus being a mode in which the television is enabled to be woken up into said higher-power mode by either one of an automated response to an incoming communication event and a manual user input from the standby button of the remote control.

The invention is particularly useful when applied to televisions having large, high-power screens such as Widescreen formats and High-Definition (HDTV) formats.

Further, according to a second aspect of the present invention, there is provided a television comprising: a television screen for displaying video signals to a user; a network interface for accessing a packet-based network; an embedded processing apparatus coupled to the network interface, arranged to execute a communication client application for receiving communication events via the network interface and packet-based network; and power-saving circuitry coupled to the television screen and embedded processing apparatus, configured to switch between: (i) a higher-power mode whereby the television screen is switched on and the embedded processing apparatus is set to a higher-power processing state, and (ii) a lower-power mode whereby the television screen is switched off and the embedded processing apparatus is set to a lower-power processing state; and a user input device communicable with the power-saving circuitry for switching between said modes, the lower-power mode thus being a mode set in response to a manual user input from the user input device; wherein the processing apparatus is configured so as, during the lower-power mode, to continue executing at least part of the communication client application so as to monitor the network interface and thereby detect an incoming communication event.

In conventional standby modes of televisions, the operation of the television's internal electronics may be suspended.

If a power supply to an electronic device is completely turned off, then the logical state of its electronics is lost. When the device is turned on again, it will therefore be found in some arbitrary, unknown state; and so the device must undergo a start-up procedure in order to get from that arbitrary, unknown state to a known, operational state. This takes time which is inconvenient for a user. For example in the case of a device containing a digital signal processor, if the power is completely turned off then the program state will be lost, as will the contents of any volatile memory. When the device is turned on again, the processor will therefore need to undergo a boot procedure in order to return to an operational state.

To avoid such inconvenience, the idea of a conventional standby mode is that the power supply to the device's electronics is maintained so as to retain the logical state of the device, but at the same time the actual operation of the electronics is suspended and so minimal current is drawn. In the case of a processor, operation may be suspended in that the processor is set to a state in which it suspends the execution of code.

However, this may cause another problem when integrating a communication client into an appliance such as a television set, again because incoming calls will be asynchronous with the current state of the television in that they are not chosen to be initiated by the user of the television but instead arrive at unpredictable times at the initiation of another, remote user, and therefore may arrive when the television is in standby mode. If the operation of the internal electronics is suspended, including suspending an embedded processor on which the client application is to be run, then this will cause a problem in that the client will be unable to detect asynchronously received incoming calls.

Thus on the one hand, a television would conventionally be kept in a low-power mode when programs are not being viewed; but on the other hand, this is at odds with the requirement of the client application to “listen out” for incoming calls that may be signalled from the network at potentially any time, asynchronously with the state of the television.

Rather than having to continue running the processing apparatus at full power at all times when the television is in standby, which would be wasteful of power, another aspect of the present invention overcome the above problem by adapting the processing apparatus to provide a special low-power processing state in which a minimal or reduced processing functionality is kept active in order to monitor the network interface for incoming calls. Thus a low-power mode of the television is provided in which the screen is switched off, as in standby, but in which the processor is neither fully suspended nor kept in a fully-operative state. Instead, the processing apparatus can be set to a lower-power processing state due to its reduced work-load.

For example, if the processing apparatus is also responsible for executing signal processing code to process received television signals for output to the screen, then this signal processing will not be required in the low-power mode. However, the whole processing apparatus cannot be set to a suspended state since it will still be required to execute at least part of the client application responsible for monitoring the network interface. On the other hand it would be wasteful to maintain the processing apparatus in a full-power state. Therefore the present invention may set the processing apparatus into a specially adapted low-power mode in which it is allowed sufficient resources to execute the client application in at least a passive “listening” state, but in which the full resources that would be required for digital signal processing are powered down.

Note that by a lower-power processing state, it is not meant just that the processor happens to consume less power because it is executing less code, but rather that the state of the processor itself is set to a lower degree of operability or functionality. I.e. the processing apparatus is less than fully operative, such that the remaining client code has available less processing resource. The lower-power processing state is specially adapted to the requirements for running at least part of a communication client application for monitoring a network interface for incoming calls.

In embodiments, the lower-power processing state could comprise reducing a clock speed of the processing apparatus, since the client application in its passive “listening” state will not require many processing cycles per unit time.

Alternatively or additionally, at least two separate processors could be provided (having separate execution units), with a first processor being arranged to execute at least the part of the communication client responsible for monitoring the network interface, and a second processor being arranged to execute additional code associated with the normal television functionality such as digital signal processing. In this arrangement the second processor could be set to a lower-power state when the television is in the lower-power mode, and preferably could have its operation completely suspended so as not to execute any of the signal processing code nor any other superfluous code.

Preferably the communication client is configured to issue one or more power control commands in order to “wake up” the television upon detecting an incoming call.

In one embodiment of the second aspect of the present invention, this wake-up procedure may comprise outputting an initial notification of the incoming call to an alternative interface such as a speaker, LED or LCD display, and awaiting the user's confirmation before turning the screen back on and returning to the processing apparatus to the higher-power state. The alternative interface could be provided on a remote control unit, with which the client application may communicate via a wireless interface such as a Bluetooth interface or other such RF interface.

In other embodiments however, the client application may automatically wake up the television without requiring confirmation of a user input.

In preferred embodiments the network interface included in the television set comprises a wi-fi transceiver or other such RF transceiver for communicating with a wireless router in the home or office. In this case the RF transceiver will be arranged to remain active during the low-power mode.

The television signals are preferably received in the form of television broadcasts, from a terrestrial, cable or satellite television network.

According to a further aspect of the invention, there is provided a communication client application embodied on a computer-readable medium and comprising code for execution on a processing apparatus of a television, the code comprising: first code configured so as when executed on the embedded processing apparatus to receive communication events via a network interface of the television to a packet-based network; and second code configured so as when executed on the processing apparatus to issue power-control commands in order to control power-saving circuitry of the media appliance, and thereby to switch between: (i) a higher-power mode in which the screen is switched on, and (ii) a lower-power mode in which the screen is switched off, the lower-power mode being a mode set in response to a manual user input from a user input device; wherein at least part of the first code is configured to continue executing on the processing apparatus during the lower-power mode, so as to monitor the network interface and thereby detect an incoming communication event, and in response to automatically trigger the power-saving circuitry to return to the higher-power mode so as to output a notification of the incoming communication event to the television screen prior to a manual response from said user.

According to another aspect of the present invention, there is provided a communication client application embodied on a computer-readable medium and comprising code for execution on a processing apparatus of a television, the code comprising: first code configured so as when executed on the embedded processing apparatus to receive communication events via a network interface of the television to a packet-based network; and second code configured so as when executed on the processing apparatus to issue power-control commands in order to control power-saving circuitry of the media appliance, and thereby to switch between: (i) a higher-power mode in which the screen is switched on, and (ii) a lower-power mode in which the screen is switched off and the processing apparatus is set to a lower-power processing state, the lower-power mode being a mode set in response to a manual user input from a user input device; wherein at least part of the first code is configured to continue executing on the processing apparatus during the lower-power mode, so as to monitor the network interface for incoming communication events.

In embodiments, the communication client may be further configured in accordance with any of the above television features.

According to a further aspect of the present invention, there is provided a method comprising: executing a communication client application on an embedded processing apparatus of a television, the communication client being operable so as when executed to receive communication events via a network interface of the television to a packet-based network; issuing power-control commands in order to control power-saving circuitry of the media appliance, and thereby to switch between: (i) a higher-power mode in which the screen is switched on, and (ii) a lower-power mode in which the screen is switched off, the lower-power mode being a mode set in response to a manual user input from a user input device; and continuing to execute at least a part of the communication client application on the processing apparatus during the lower-power mode, so as to monitor the network interface and thereby detect an incoming communication event, and in response to automatically trigger the power-saving circuitry to return to the higher-power mode so as to output a notification of the incoming communication event to the television screen prior to a manual response from said user.

According to another aspect of the present invention, there is provided a method comprising: executing a communication client application on an embedded processing apparatus of a television, the communication client being operable so as when executed to receive communication events via a network interface of the television to a packet-based network; issuing power-control commands in order to control power-saving circuitry of the media appliance, and thereby to switch between: (i) a higher-power mode in which the screen is switched on, and (ii) a lower-power mode in which the screen is switched off and the processing apparatus is set to a lower-power processing state, the lower-power mode being a mode set in response to a manual user input from a user input device; and continuing to execute the communication client application on the processing apparatus during the lower-power mode, so as to monitor the network interface for incoming communication events.

In embodiments the method may comprise further steps in accordance with any of the above television features.

### BRIEF DESCRIPTION OF THE DRAWINGS

For a better understanding of the present invention and to show how it may be put into effect, reference is made by way of example to the accompanying drawings in which:

FIG. 1 is a schematic representation of a communication system,

FIG. 2 is a schematic representation of a remote control unit,

FIG. 3a is a schematic block diagram of a television set,

FIG. 3b is another schematic block diagram of a television set,

FIG. 4 is a schematic representation of a user interface,

FIG. 5a schematically illustrates an incoming call notification,

FIG. 5b schematically illustrates another incoming call notification, and

FIG. 6 is a schematic block diagram of a processor.

### DETAILED DESCRIPTION

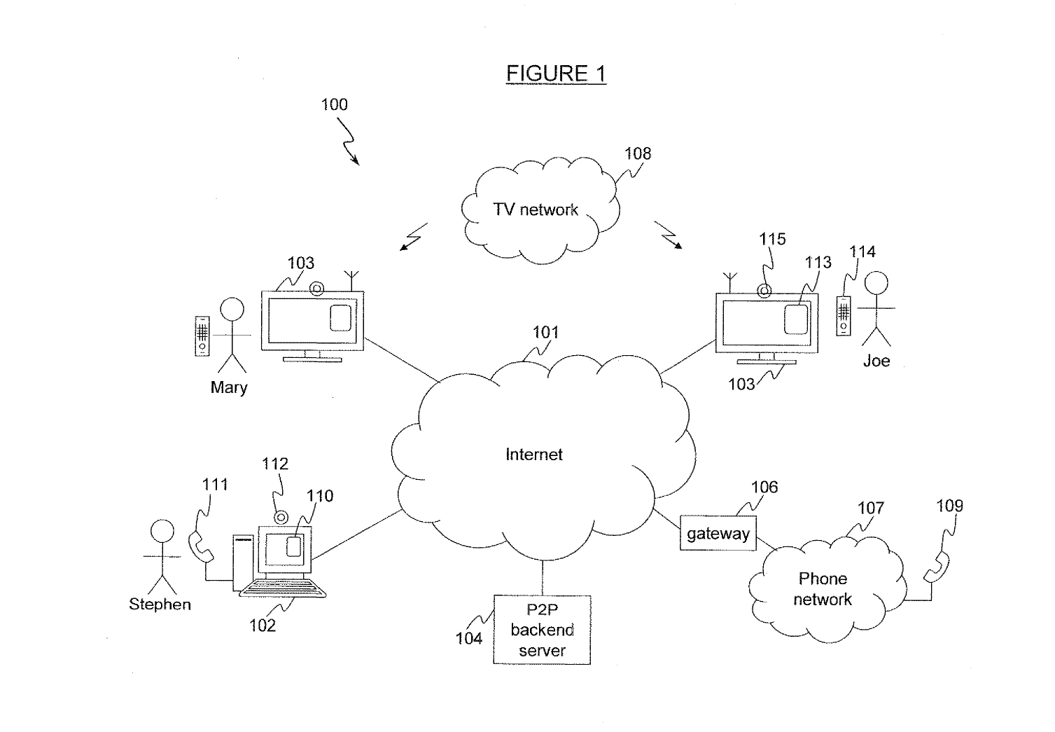

FIG. 1 shows a communication system 100 comprising a packet-based network 101 such as the Internet; and further comprising a separate television broadcasting network 108 such as a terrestrial, satellite or cable television network. A plurality of computer terminals 102 are shown coupled to the Internet 101, each comprising a network interface for communicating over the Internet. A plurality of television sets 103 are also shown coupled to the Internet 101, each of which also comprises a network interface for communicating over the Internet. In addition to the network interface, each television set 103 further comprises a television receiver for receiving analogue and/or digital television signals which are broadcast over the television network 108. Alternatively or additionally, a television set 103 could be arranged to receive packet-based television signals over the Internet 101 or other such packet-based network. However, broadcast television is still popular at the time of writing and so in preferred embodiments the television set 103 will comprise a television receiver for receiving broadcasts at least.

The difference between a broadcast and a communication made over a packet-based network is that broadcast signals are transmitted indiscriminately, without transmitting to selected destination devices and regardless of whether the end-user has selected to receive the signal (although a decryption key or such like may still be required so that only authorised users can derive meaningful information from the television signal for viewing). Packet-based communications on the other hand are point-to-point, with an address of the intended destination device being included in the packets. In the case of packet-based television signals transmitted over the Internet, these are still point-to-multipoint communications rather than a broadcast.

Each computer terminal 102 is installed with a communication client application 110. Each computer terminal 102 also comprises an audio transceiver 111 comprising a speaker and microphone, e.g. in the form of a headset or handset, or a built-in speaker and microphone. Most computer terminals 102 preferably also comprise a webcam 112. Furthermore, each television set 103 comprises an embedded processor and memory installed with a version of the communication client application 113 specially adapted for running on a television set. Each television set 103 also comprises a webcam 115 and an audio transceiver with speaker and microphone, or is connected or communicable with such components. In a particularly preferred embodiment an audio transceiver is provided in a remote control unit 114 of the television 103, discussed shortly.

The communication client applications 110 and 113 are preferably peer-to-peer clients for setting-up and conducting VoIP calls according to peer-to-peer principles as discussed above. To that end, a peer-to-peer backend server 104 is coupled to the Internet 101 for receiving registration requests from the client applications 111 and 113. The back-end server 104 is arranged to distribute UIC certificates to the respective client applications 111 and 113 running on the computer terminals 102 and television sets 103 in response to the registration requests. Once registered and thus in possession of a UIC certificate, the client applications 111 and/or 113 can look-up one another's addresses, exchange and authenticate one another's certificates, and thus establish a voice or video call over the Internet 101. It will be appreciated however that other kinds of communication client could alternatively be used, e.g. based on centralized server-based call set-up.

In addition, the communication system 100 may comprise a telephone network 107 such as a circuit-switched network, and a gateway 106 connecting between the Internet 101 and the telephone network 107. A gateway version of the client application is arranged to run on the gateway 106, and a communication client application 110 or 113 running on a computer terminal 102 or television set 103 is thus able to establish a call with a dedicated phone unit 109 of the telephone network 107. This is achieved by establishing a connection with the client on the gateway 106 using peer-to-peer call set-up and then supplying the relevant telephone number to the gateway 107 (effectively the user's client 110 or 113 sees the gateway 106 as a peer). The phone network 107 may for example comprise a fixed-line network (“landline”) and/or a mobile cellular network.

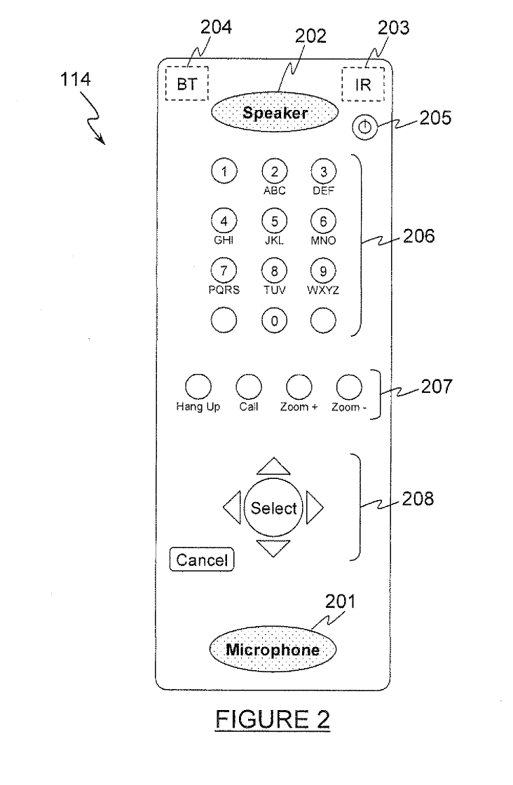

Each television set 103 has an associated remote control unit 114, an example of which is illustrated in FIG. 2.

As shown in FIG. 2, the remote control unit (or just “remote control”) comprises a microphone 201, speaker 202, a first remote interface in the form of an infrared (IR) transmitter 203, and a second remote interface in the form of a short-range RF interface 204 such as a Bluetooth interface. The microphone 201 and speaker 202 are operatively coupled to the Bluetooth interface 204. The remote control 114 is thus arranged to communicate voice signals from the microphone 201 to the television 103 via the Bluetooth interface 204, and to receive voice signals from the television 103 via the Bluetooth interface 204 for playing out of the speaker 202.

The remote control 114 further comprises a plurality of buttons operatively coupled to the infrared transmitter 203, arranged so as to allow the user to control the television 103 via the infrared transmitter 203. The buttons comprise a “standby” button 205 for setting the television into a low-power mode (though not a conventional standby mode). The buttons further comprise numerical or alphanumeric buttons 206 for changing channel or supplying other numerical or alphanumerical data to the television 103; function buttons 208 for controlling various functions of the television 103, e.g. for controlling a cursor and/or menu system; and optionally dedicated calling buttons 207 for performing specific dedicated operations relating to the calling functionality of the client application 113, e.g. “call”, “hang up”, or buttons for zooming in and out during a video call.

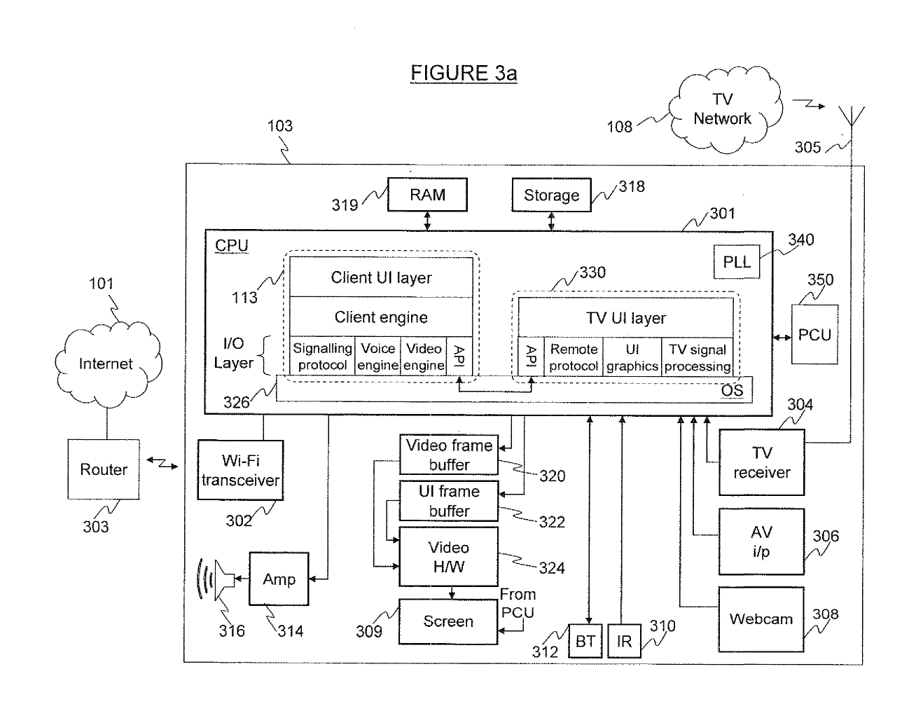

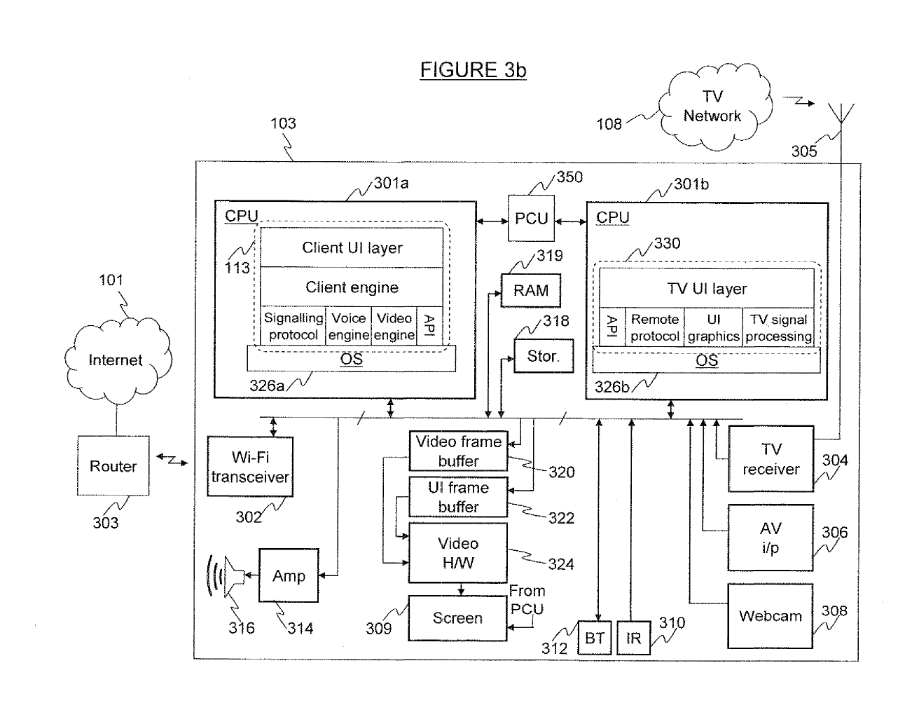

FIG. 3a is a schematic block diagram of a television set 103 according to an exemplary embodiment of the present invention. The television set 103 is a dedicated television unit in the sense that its primary purpose is as a television, and is designed to fulfil the role of a family or household television. However, at the same time it is additionally provided with secondary embedded functionality such as VoIP calling.

The televisions set 103 comprises, within a single casing: an embedded processing apparatus 301; a random access memory (RAM) 319; and an embedded non-volatile storage device 318 which may comprise an electronically erasable and reprogrammable memory (EEPROM or “flash” memory), a magnetic storage medium, and/or a one-time writable ROM. The non-volatile storage device 318 is coupled to the processing apparatus 301 and stores a basic operating system (OS) 326, a television application 330, and a communication client application 113 such as a VoIP client. The processing apparatus 301 is arranged to execute the operating system 326, e.g. either by fetching instructions directly from ROM or by first loading from a flash memory into the RAM 319 before fetching. When executed, the operating system 326 is configured to load the television application 330 and client application 113 into RAM 319 and schedule them for execution on the processing apparatus 301. The processing apparatus 301 is thus arranged to run the television application 330 and client application 113 under control of the operating system 326. In embodiments only a minimal operating system 326 may be required, in the form of a basic scheduler.

The television set 103 further comprises, within the same casing: a video frame buffer 320 and user interface (UI) frame buffer 322, video hardware 324, a screen 309, an amplifier 314 and speaker 316 or output to an external speaker or headphones, a television receiver 304, an external audio-video (AV) input 306 such as a SCART or HDMI input from an external source, a webcam or webcam input 308 for connecting to an external webcam, a network interface 302 in the form of a first short-range RF transceiver such as a wi-fi transceiver, a first remote interface 310 in the form of an infrared (IR) receiver, a second remote interface in the form of a second short-range RF transceiver 312 such as a Bluetooth transceiver, and a power control unit (PCU) 350. The screen may be a large and/or high performance screen which incurs a lot of power, such as one of the standardized formats referred to in the art as “High Definition” (HDTV, or sometimes just HD).

The video frame buffer 320 and user interface (UI) frame buffer 322 each have an input coupled to the processing apparatus 301. The video hardware 324 has an input coupled to the outputs of the video frame buffer 320 and UI frame buffer 322. The screen 309 has an input to the output of the video hardware 324. In embodiments, the frame buffers 320 and 322 could be dedicated hardware buffers or alternatively could be implemented in a general purpose memory. The amplifier 314 has an input coupled to the processing apparatus 301 and an output coupled to the speaker 316. The processing apparatus 301 is further coupled to the network interface 302, television receiver 304, auxiliary input 306, webcam input 308, infrared interface 310, and Bluetooth interface 312.

Any or all of the above components may be coupled to the processing apparatus 301 via intermediate components such as a bus and/or cache (not shown), as will be understood by a person skilled in the art.

The power control circuitry 350 may comprise on-chip circuitry of the processing apparatus 301 and/or off-chip circuitry coupled to the processing apparatus 301. The power control circuitry may also be coupled to additional components such as the screen 309 and associated hardware which can be powered down in a low-power mode.

The television receiver 304 comprises an input for connecting to at least one reception means such as an antenna, satellite dish or cable line, and is thus arranged to receive television broadcast signals from the television network 108 via the reception means. The television receiver 304 is a hardware front-end which may comprise for example: sampling circuitry, a low noise amplifier, a filter, a mixer, and/or an analogue-to-digital converter (ADC). Once received by the television receiver unit 304, the television signals are thus made available to the processing apparatus 301 for signal processing. The television application 330 comprises a signal processing engine in the form of code which, when executed, performs at least some of the required signal processing on the received television signals. The processed television signals are then output to the video frame buffer 320 and amplifier 314 for consumption by the end user. The signal processing engine may comprise for example: a digital filter, demodulator, demultiplexer, decoder, decryption block, and/or error checking block. However, different ways of allocating the television receiver and processing functionality between software and dedicated hardware are also possible. E.g. in embodiments, more of the functionality such as the demultiplexing could be moved to the receiver front-end 304. Techniques for receiving and processing television signals will be known to a person skilled in the art.

In the case of traditional analogue television broadcasts, the signals of a plurality of different concurrent programs (of different TV channels) are frequency-division multiplexed over the airwaves by being transmitted on different frequencies. The television receiver 304 will then comprise a tuning circuit to demultiplex the broadcasts and thereby separate out the signal of the required programme. In the case of digital television broadcasts, the signals of different concurrent programs are each divided into packets and interleaved so as to time-division multiplex the different programs' signals into a transport stream for broadcast. The signal processing engine of the television application 330 will then comprise a packet filter to demultiplex the packets of different transport streams and so separate out the signal of the required programme. Multiple transport streams may also be broadcast on different frequencies, requiring a tuner as well. Furthermore, for digital television, one or more of the transport streams may comprise additional programme information such as an electronic programme guide (EPG).

Video signals for output to the television screen 309 may also be received via the AV input 306 from an external source such as a DVD player or games console.

The television application 330 further comprises a UI graphics engine, a remote protocol engine, an application programming interface (API), and a television UI layer. The overall operation of the signal processing engine, UI graphics engine, remote protocol engine and API is controlled by the television UI layer. The user can select which broadcast to view by pressing buttons 205, 206, 208 on the remote control 114, causing the remote control 114 to communicate control signals to the processing apparatus 301 via the infrared transmitter 203 and receiver 310. The user may also use the buttons in a similar manner to view additional information such as the EPG or control menus, and to navigate the EPG or menus. The relevant control signals are interpreted by the remote protocol engine of the television application 113, which in turn communicates with the television UI layer. In response, the television UI layer controls the signal processing engine to output the relevant television programme to the video frame buffer 320, and/or controls the UI graphics engine to output graphics to the UI frame buffer 322 (e.g. to display the graphics of the menu or EPG). The frame buffers 320 and/or 322 supply their contents to the video hardware 324 for display on the screen 309. In embodiments the UI frame buffer 322 and video hardware 324 may be arranged to overlay UI graphics over the current television programme in a partially transparent manner, and/or to leave at least part of the television programme visible.

As mentioned, the television set 103 comprises a network interface 302. In preferred embodiments this takes the form of a wireless transceiver such as a wi-fi transceiver, for communicating wirelessly with a household or office-based wireless router 303 as found in most modern homes or offices. The router 303 in turn connects to the Internet 101. However, in alternative embodiments the network interface 302 may comprise other options such as a wired modem or a port to an external wired modem.

The communication client application 330 comprises a protocol stack having an I/O layer which, when executed on the processing unit 301, is operable to transmit and receive signals over the Internet 101 via the network interface 302. The I/O layer comprises a network signalling protocol for transmitting and receiving control signals over the Internet 101 via the network interface 302. The I/O layer may also comprise an API for communicating with the API of the television application 301.

The I/O layer further comprises a voice engine comprising a voice codec. The voice engine is arranged to accept speech signals from the microphone 201, and to encode those speech signals for transmission over the internet 101 via the network interface 302. The voice engine is also arranged to decode speech signals received over the Internet 101 via the network interface 302, for output to the television's amplifier 314 and speaker 316, or to the speaker 202 in the remote control 114 via the Bluetooth interfaces 312 and 204. The I/O layer further comprises a video engine comprising a video codec. The video engine is arranged to accept video signals from the webcam input 308, and to encode those video signals for transmission over the Internet 101 via the network interface 302. The video engine is also arranged to decode video signals received over the Internet 101 via the network interface 302, for output to the UI frame buffer 322, video hardware 326 and screen 309. Alternatively, in a full-screen mode the video codec could output video via the video frame buffer 320.

Higher up the protocol stack, the client application 113 comprises a client engine which is responsible for call-set up. The client engine controls the network signalling protocol engine of the client 113 in order to establish a live voice or video call with another user terminal 102 or 103 over the Internet 101, preferably using P2P call set-up as discussed above, or potentially using a centralized call set-up via a server. The client engine may also handle other functions such as connection management, authentication, encryption, and/or exchanging presence information with the client applications 111 or 113 of other user terminals (presence information indicates the availability of a user for communication, and is preferably at least partially defined by the respective user themselves).

Even higher up the protocol stack, the client application 113 comprises a client UI layer which is responsible for the client's user interface. The client UI layer is operable to generate a client user interface for output to the UI frame buffer 322, video hardware 324 and screen 309. This may be output via the APIs and the UI graphics engine of the TV application 330 under control of the TV UI layer (or alternatively the client application 113 could be provided with its own UI graphics protocol to output graphics to the UI frame buffer 322 directly). The client user interface thus presents the user with on-screen controls which they can activate using buttons 206, 207, 208 on the remote control 114. Based on these button presses, the remote control 114 communicates control signals to the processing apparatus 301 via the infrared transmitter 203 and receiver 310. These control signals may be interpreted by the UI protocol engine in the television application 330 and then signalled via the APIs to the I/O layer of the client application 113 (or alternatively the I/O layer of the client application 113 could be provided with its own remote control protocol to interpret these control signals directly). In turn, the protocol of the I/O layer of the client 113 communicates with the client UI layer. The client UI layer is thus configured to respond to user inputs in order to control the overall operation of the client application 113, e.g. allowing a user to select contacts to call, hand up, etc.

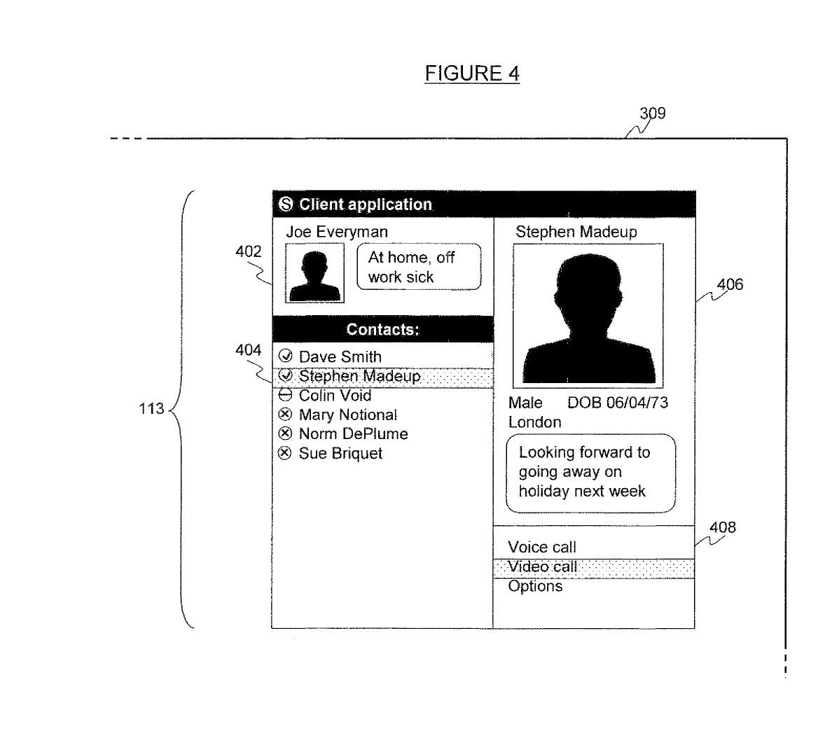

FIG. 4 illustrates an example user interface which could be displayed on the screen 309 by the client application 113, when summoned by the user using the relevant buttons of the remote 114. The user interface may be displayed only on part of the screen 309, allowing at least a portion of a currently viewed programme to remain visible; or may alternatively take up the whole screen 309. The displayed user interface comprises a number of panels. For example, the user interface may comprise a first panel 402 showing profile information of the user of the television 103 on which the client 113 is running E.g. the profile information may comprise the user's name, an “avatar image” (a picture which the user has chosen to represent themselves), and/or a “mood message” (a short user-defined statement for inclusion in their profile). Further, the user interface may comprise a second panel 404 showing a list of the user's contacts (preferably the client 113 is configured to only allow calls between users who have agreed to be contacts). Further, the user interface may comprise a third panel 406 showing a profile of a selected one of the contacts, and/or a fourth panel 408 providing a menu or other controls for selecting to call the selected contact.

Furthermore, the UI layer of the client 113 may be configured to communicate with the UI layer of the television application 330, via the APIs and the operating system 326. This allows the client application 113 and television application 330 to negotiate control of the screen 309 and/or speaker 316 or 202.

Whether the client application 113 or television application 330 takes precedence may depend on the implementation and/or situation. Since the television set 103 is primarily a television, then preferably the client application 113 should require permission from the television application 330 before controlling the screen 309 or speaker 316 or 202. However, in embodiments a user-defined setting may be provided allowing the user to control whether or not the client application 113 can autonomously take control of the screen 309 and/or speaker 316 or 202, e.g. to notify the user in event of an incoming call. The setting would preferably be stored in a non-volatile memory 318 and be readable by the client application 113 and/or television application 330.

As mentioned, the user can put the television 103 into a low-power mode by pressing the “standby” button 205 on the remote control 114, which signals to the power control unit 350 via the infrared transmitter 203 and receiver 310 to turn off the screen 309. The low-power mode is thus a user-selected mode manually chosen by the user (e.g. rather than falling into the low power mode after a predetermined period of inactivity as on a computer such as a PC). This infrared receiver 310 may be connected so as to act directly on the power control unit 350 or via the UI layer of the television application 330.

Ostensibly the television set 103 is thus put into a “standby” mode from the perspective of the user. However, in fact operation of the processor 301 cannot be completely suspended because the client engine of the communication client application 113 still needs to monitor the network interface 302 (via the network signalling protocol engine in the I/O layer of the client 113). On the other hand, continuing to maintain the processor in a full state of operability would be wasteful of power, since only limited processing resources will be required to perform this basic functionality of the client application 113. Therefore rather than a conventional standby mode, the “standby” button 205 actually places the television 103 into a special low-power mode in which the screen is turned off and the processing apparatus 301 is placed into a lower-power processing state with reduced operability. In this state the processing apparatus 301 is still capable of running at least the part of the client application 113 responsible for monitoring the network interface 302 and “waking up” again if an incoming call is detected, but preferably need not be able to adequately run the full signal processing engine of the television application 330 for example, and indeed need not necessarily be able to run the voice and/or video engine of the client application 113 either.

In one embodiment as shown in FIG. 3a, the processing apparatus 301 comprises a central processing unit (CPU) which is arranged to execute both the client application 113 and the television application 330. The processor 301 comprises clock circuitry in the form of a phase-locked loop (PLL) 340 which is configured to clock the CPU 301 on which the client application 113 and television application 113 are executed. The PLL 340 has a variable clock rate, and is therefore arranged to control the number of processor cycles per unit time used to execute the applications on the CPU 301. The PLL 340 is operatively coupled to the power control unit 350. When the power control unit 350 is operated to place the television set 103 into the low power mode, it both turns off the screen 309 and also controls the PLL 340 to reduce the clock speed of the CPU 301. In addition, the operating system 326 also de-schedules the television application 330 from being executed on the CPU 330 (either in response to a signal from the power control unit 350 or directly from the infrared receiver 310). Other components such as the television receiver 304 and video hardware 324 may also be powered down, although note that the network interface 302 is kept active.

This lower-power mode advantageously saves the power that would be required to keep clocking the processor at full speed, but this is still sufficient from a point of view of processing resources because the part of the client application 113 responsible for monitoring the network interface 302 will require only a very limited number of processor cycles per unit time.

When the client application 113 detects that an incoming call has been signalled from the network 101 via the network interface 302, there are at least two options for the wake-up procedure.

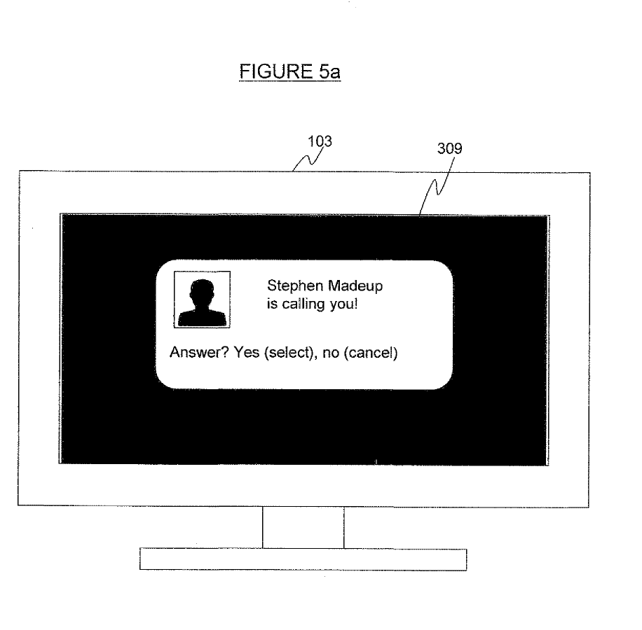

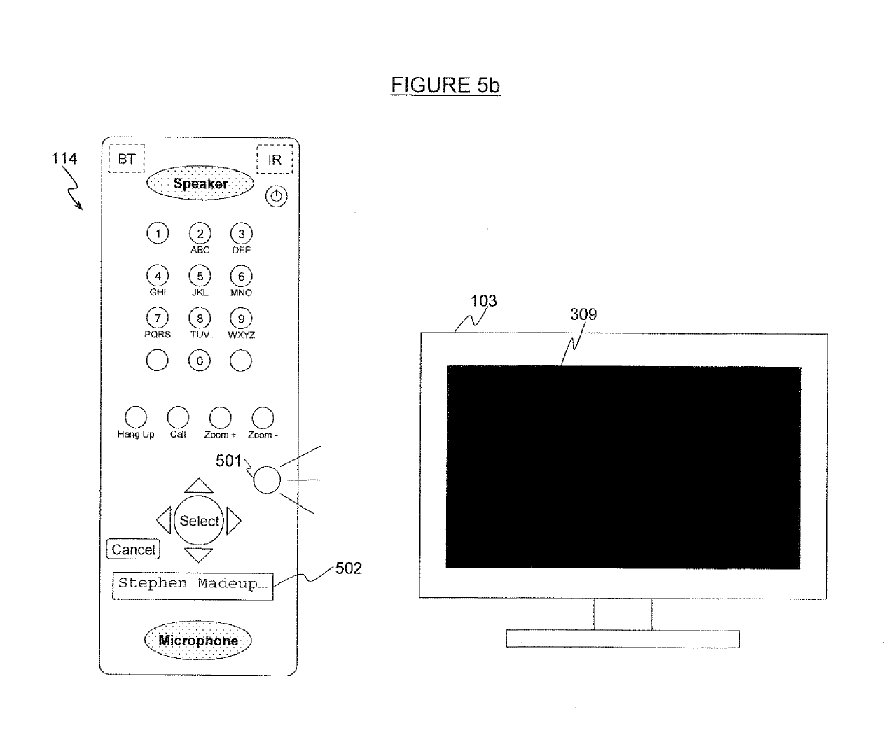

As illustrated in FIG. 5a, the first option is for the client application 113 to automatically issue a power control command to the power control unit 350 without waiting for approval from the user. In response, the power control unit 350 turns the screen 309 back on. The client application 113 then uses the screen 309 to prompt the user with a message notifying him or her of the incoming call, and providing the option for the user to answer or decline the call using buttons 207 or 208 on the remote control 114. If the user accepts, the client application 113 issues another power control command to the power control unit 350, which places the processing apparatus 301 back into the full-power state. The client application 113 then proceeds with the call. If the user declines the call on the other hand, the client 113 issues a power control command to the power control unit 350 instructing it to turn the screen back off, then continues to monitor the network interface 302. Similarly, if the user makes no selection and so neither accepts or declines the call, e.g. because he or she is not within a suitable vicinity at the time, then the notification may time-out after a certain time period, or the remote user may hang-up. Either way, the client 113 would also then issue a power control command to the power control unit 350 instructing it to turn the screen back off, then continue to monitor the network interface 302.

In a variant of this first option, the processing apparatus 301 could be returned to the full-power state at the same time as turning on the screen 309 when the client 113 first detects the incoming call, e.g. in response to a single power control command form the client application 113. However, that could turn out to be unnecessary if the user subsequently declines the call.

In another variant of the first option, the processing apparatus 301 need not be provided with different power states at all. In this case only the screen 309 need be turned off in the low power modem and automatically turned on again in response to detecting the incoming call.

The first option has the advantage that the user can be provided with information about the call before deciding whether to answer or decline. For example, the on-screen notification preferably comprises a name of the caller and potentially other profile information such as an avatar image.

As illustrated in FIG. 5b, the second option is for the remote control 114 to be provided with an alternative user interface such as an LED 501 or remote display 502 such as an LCD display. In this case, when the client application detects an incoming call signalled from the network 101 to the network interface 302, it does not immediately issue a power control command. Instead, it sends a signal to the alternative interface 501 or 502 of the remote control 114, via the Bluetooth interfaces 312 and 204 or other such suitable interface. In response, the alternative interface 501 or 502 alerts the user to the incoming call. For example the LED 501 may flash and/or the remote display 502 may display information signalled from the client 113 such as the name of the caller. Alternatively or additionally, the client 113 could signal to another kind of alternative interface, e.g. by outputting an audio alert to the speaker 202 on the remote control 114 or to the speaker 316 in the television set 103 itself. In response, the user can choose to answer or decline the call using the buttons 207 or 208 on the remote control 114.

This second option does not necessarily allow the user to see details of the call before answering, but has another advantage in that neither the screen 309 nor processing apparatus 301 need be woken up unless the user answers the call. If the user does indeed answer the call then the client application 113 issues one or more power control commands to the power control unit 350 instructing it to turn on the screen 309 and return the processing apparatus 301 to the full power state, and the client application 113 then proceeds with the call. If the user declines on the other hand, the client 113 simply continues to monitor the network interface 302 and leaves the television in the low-power mode. Similarly, if the user makes no selection and so neither accepts or declines the call, e.g. because he or she is not within a suitable vicinity at the time, then the notification may time-out after a certain time period, or the remote user may hang-up. Either way, the client 113 would also leave the television in the low-power mode and just continue to monitor the network interface 302.

Also, in either option, note that the user can always select to return the television set 103 to the full power-mode at any time by pressing the “standby” button 205.

In further embodiments as shown in FIG. 3b, the processing apparatus 301 comprises a plurality of CPUs, with at least a first CPU 301a being arranged to execute the client application 113, and a second CPU 301b being arranged to execute the television application. At least the second CPU 301b is coupled the power control unit 350. In this embodiment, the power control unit 350 is arranged to place the processing apparatus 301 into the low-power state by placing the second CPU 301b into a low-power state, preferably by suspending operation of the second CPU 301b. This will involve ceasing to fetch and execute instructions, and optionally additional measures such as saving the program state. However, the suspended state will not mean completely losing the logical state of the second CPU 301b such that it would need to be re-booted when returning to the full-power state.

Alternatively, the second CPU 301b could only be set to a state of reduced operability in the low-power mode, e.g. with reduced clock speed. This could be useful if the second CPU 301b has other tasks to perform during the low-power mode.

This embodiment can be used either as an alternative to that of FIG. 3a, or in addition. For example, as well as suspending the second CPU 301b, the power control unit 350 could also reduce the clock speed of the first processor 301a-because the client application 113 is unlikely to incur the processor's full resources when only required to monitor the network interface 302 for incoming calls (the voice or video codecs are the most processor-intensive parts of the client application 113, but these are only active during a call).

The features for notifying the user of incoming events, waking up the television, and accepting and declining calls as discussed in relation to FIGS. 5a and 5b may also apply in relation to the embodiment of FIG. 3b.

In either embodiment, the wake-up may also involve the operating system 326 re-scheduling the television application 330 (either in response to a signal from the power control unit 350 or directly from the client application 113). However, that may only be required in certain embodiments or situations, e.g. if the client application 113 must run under control of the television application 330, or if the user wishes to view a television program during the call. For example, users of two or more televisions 103 could conduct a voice call in which they discuss an ongoing program.

On the other hand, if a user answers a call without wanting to simultaneously watch a television program, one or more intermediate power modes may be provided in which the processing apparatus 301 runs at a sufficient level to execute voice and/or video codecs of the client application 113 (as well as the client engine and client UI layer), but without the full level of operability required to run all the signal processing engine of the television application 330. E.g. in the example of FIG. 3a the PLL 340 could be set to an intermediate clock speed, or in the example FIG. 3b the second CPU 301b could remain suspended. Furthermore, in the case of a voice-only call, the television screen 309 need not necessarily be turned back on in the intermediate mode either. The intermediate mode would be invoked by the client application 113 issuing one or more suitable power control commands to the power control unit 350, in a similar manner to switching between the low and high power modes discussed above. The selection as to whether to enter the intermediate mode or higher power mode when answering a call would preferably be made in dependence on a user input from the remote 114 or based on a user setting.

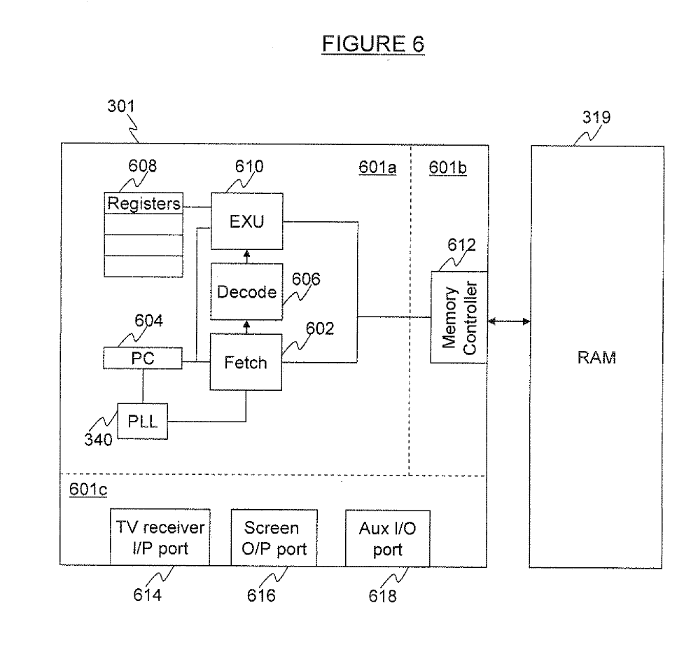

An example processor architecture is illustrated schematically in FIG. 6. This could represent the CPU of FIG. 3a, or either of the first CPU 301a or second CPU 301b of FIG. 3b. The CPU comprises the PLL 340, a fetch unit 602, a program counter 604 coupled to the fetch unit, a decode unit 606 coupled to the fetch unit, an execution unit 610 coupled to the decode unit, a bank of registers 608 coupled to the execution unit, and a memory controller 612 coupled to the fetch unit and execution unit. The memory controller 612 is coupled to the RAM 319. The fetch unit 602 is arranged to fetch instructions of the program from an address of the RAM 619 determined in dependence on the program counter 604, then pass each instruction in turn through the decode unit 606 and execution unit 610 for execution. The execution unit 610 can access the RAM 619 and the registers 608 for various purposes involved in the execution. The execution unit 610 can also access the program counter to perform control flow operations such as branching to a different point in the program.

The PLL 340 is arranged to clock the fetch unit 602 and program counter 604 (and indeed other components such as the execution unit 610). In embodiments where the low-power state comprises a reduced clock speed, the PLL 340 is configured to reduce the rate at which the program counter 604, fetch unit 606 and/or execution unit 610 are clocked, such that the program progresses at a reduced speed and fewer instructions are fetched from memory 619 per unit time.

In embodiments where the low-power state comprises suspending operation of the second CPU 301b, the program counter 604 is configured to cease incrementing and the fetch unit 602 is configured to cease fetching instructions from memory. Therefore in the suspended state, no new instructions are fetched for execution by the execution unit 610, and the execution unit 610 does not execute instructions. Further, the program state represented by the values in the program counter 604 and/or registers 608 may be saved to memory, e.g. to the RAM 619 or a non-volatile memory, from whence they can be loaded again upon return from the low-power state.

It will be appreciated that the above embodiments have been described only by way of example.

For instance, the present invention is not limited to any one particular technique for placing the processing apparatus into a lower power state. Other suitable techniques for reducing the power consumption of a processor may be used. For example, some processors have different regions or “domains” 601 which can operate at different clock speeds and/or different operating voltages, with clock converters and/or voltage level shifters being provided to transfer signals between the different domains. These different domains typically handle different kinds of operation. E.g. the core operating voltage of a processor may be lower than the operating voltage at periphery regions responsible for interfacing with external components. In this kind of arrangement, certain domains could of the processor could be set to a lower-power or suspended state, e.g. by powering-down a peripheral interface or port 614, 616, 618 of the processor responsible for interfacing with a peripheral component such as a television receiver, auxiliary input, and/or screen buffers and video hardware associated with the screen.

Further, other ways of allocating the various client, television and other functionality amongst different processors are envisaged. For example, one or more dedicated signal processors (DSPs) could be arranged to execute the television signal processing engine of the television application 330 and/or the video engine and/or voice engine of the client application 113; with one or more separate CPUs being arranged to execute the UI layer, client engine, protocol and graphics engines of the client application 113 and/or the UI layer and protocol and graphics engines of the television application 330. Some or all of the functionality of the television application 330 could alternatively be implemented in dedicated hardware, including the possibility of hardwired signal processing apparatus in the television receiver front-end 304. Another arrangement would be to provide a very basic, dedicated, low-power CPU for running only the part of the client application 113 responsible for monitoring the network interface 302 and waking up the television 103, with the rest of the client application 113 being implemented in one or more separate CPUs such as a general purpose CPU also used to execute some or all of the television application 330.

Further, the present invention need not be limited by television broadcasts. With increasing popularity of packet-based television services, there may be interest in the idea of a dedicated television set with the capability of receiving packet-based television signals, either over the Internet or a dedicated packet-based service.

The client may also be configured to wake up the television in response to other kinds of incoming communication events such as incoming file transfers. Furthermore, note that the present invention is not limited particularly to VoIP or to a peer-to-peer topology. Other packet-based networks, protocols and methods of call set-up may also be used.

Other variations of the present invention may be apparent to a person skilled in the art given the disclosure herein. The scope of the present invention is not limited by the described embodiments, but only by the appendant claims.

What is claimed is:

1. A television comprising:
a television screen for displaying video signals to a user;
a network interface for accessing a packet-based network;
processing apparatus coupled to the television screen and network interface, arranged to execute a communication client application for receiving communication events via the network interface and packet-based network;
power-saving circuitry coupled to the television screen and processing apparatus, configured to switch between (i) a higher-power mode in which the television screen is switched on, and (ii) a lower-power mode in which the television screen is switched off; and
a user input device communicable with the power-saving circuitry for switching between said modes, the lower-power mode thus being a mode set in response to a manual user input from the user input device;
wherein the processing apparatus is configured so as, during the lower-power mode, to continue executing at least part of the communication client application so as to monitor the network interface and thereby detect an incoming communication event, and in response to automatically trigger the power-saving circuitry to switch to the higher-power mode so as to output a notification of the incoming communication event to the television screen prior to a manual response from said user.

2. The television of claim 1, wherein:
the communication event is a voice or video call, the communication client application being for conducting voice or video calls via the network interface and packet-based network; and
the processing apparatus is configured so as, during the lower-power mode, to continue executing at least part of the communication client application so as to monitor the network interface and thereby detect an incoming call, and in response to automatically trigger the power-saving circuitry to return to the higher-power mode so as to output a notification of the incoming call to the television screen prior to a manual response from said user.

3. The television of claim 1, wherein the user input device comprises a remote control unit having a standby button for switching between the higher-power mode and the lower-power mode, the lower-power mode thus being a mode in which the television is enabled to be woken up into said higher-power mode by either one of an automated response to an incoming communication event and a manual user input from the standby button of the remote control.

4. The television of claim 1, wherein: the power-saving circuitry is configured to switch between: (i) a higher-power mode whereby the television screen is switched on and the processing apparatus is set to a higher-power processing state, (ii) a lower-power mode whereby the television screen is switched off and the processing apparatus is set to a lower-power processing state.

5. The television of claim 4, wherein:
the power-saving circuitry is configured to switch between: (i)(a) a first higher-power mode whereby the television screen is switched on but the processing apparatus is set to a lower-power processing state, (i)(b) a second higher-power mode whereby the television screen is switched on and the processing apparatus is set to a higher-power processing state, and (ii) a lower-power mode whereby the television screen is switched off and the processing apparatus is set to a lower-power processing state; and
the client application is configured to trigger the first higher-power mode in response to detecting the incoming communication event in order to output the notification, and to trigger the second higher-power mode in response to a user input accepting the communication event in order to process the event.

6. The television of claim 4, wherein the processing apparatus comprises at least a first processor arranged to execute the communication client application, and the lower-power processing state comprises a state in which a clock speed of the first processor is reduced.

7. The television of claim 4, wherein: the processing apparatus comprises a first processor arranged to execute at least said part of the client application, and a second processor arranged to execute signal processing code for processing television signals for output to the television screen; and the lower-power processing state comprises a state in which the second processor is set to a lower-power processing state.

8. The television of claim 7, wherein the lower-power processing state comprises a state in which operation of the second processor is suspended.

9. The television of claim 1, wherein the processing apparatus is coupled to the television screen and further arranged to execute signal processing code for processing the television signals for output to the television screen, and wherein the power-saving circuitry is configured such that the signal processing code is scheduled for execution in the higher-power mode and de-scheduled in the lower power-mode.

10. The television of claim 1, wherein the network interface comprises a wireless RF transceiver configured to stay active during the low-power mode.

11. The television of claim 1, comprising a television receiver for receiving the television signals from a television broadcasting network.

12. The television of claim 1, wherein the network interface is for accessing the internet, and the communication client application is a VoIP client for conducting voice or video calls over the internet.

13. The television of claim 1, wherein the communication client application is a peer-to-peer client for establishing a call by peer-to-peer call set up.

14. The television of claim 1, wherein the television screen is a High-Definition (HDTV) format screen.

15. A television comprising:
a television screen for displaying video signals to a user;
a network interface for accessing a packet-based network;
an embedded processing apparatus coupled to the network interface, arranged to execute a communication client application for receiving communication events via the network interface and packet-based network; and
power-saving circuitry coupled to the television screen and embedded processing apparatus, configured to switch between: (i) a higher-power mode whereby the television screen is switched on and the embedded processing apparatus is set to a higher-power processing state, and (ii) a lower-power mode whereby the television screen is switched off and the embedded processing apparatus is set to a lower-power processing state; and
a user input device communicable with the power-saving circuitry for switching between said modes, the lower-power mode thus being a mode set in response to a manual user input from the user input device;
wherein the processing apparatus is configured so as, during the lower-power mode, to continue executing at least part of the communication client application so as to monitor the network interface and thereby detect an incoming communication event.

16. The television of claim 15, wherein the communication event is a voice or video call, the communication client application being for conducting voice or video calls via the network interface and packet-based network; and
the processing apparatus is configured so as, during the lower-power mode, to continue executing at least part of the communication client application so as to monitor the network interface and thereby detect an incoming call.

17. The television of claim 15, wherein the user input device comprises a remote control unit having a standby button for switching between the higher-power mode and the lower-power mode, the lower-power mode thus being a mode in which the television is enabled to be woken up into said higher-power mode by either one of an automated response to an incoming communication event and a manual user input from the standby button of the remote control.

18. The television of claim 15, wherein the processing apparatus comprises at least a first processor arranged to execute the communication client application, and the lower-power processing state comprises a state in which a clock speed of the first processor is reduced.

19. The television of claim 15, wherein: the processing apparatus comprises a first processor arranged to execute at least said part of the client application, and a second processor arranged to execute signal processing code for processing television signals for output to the television screen; and the lower-power processing state comprises a state in which the second processor is set to a lower-power processing state.

20. The television of claim 19, wherein the lower-power processing state comprises a state in which operation of the second processor is suspended.

21. The television of claim 15, wherein the processing apparatus is communicable with an alternative user-interface other than said television screen, and is configured to automatically prompt the user via the alternative user-interface in response to detecting an incoming communication event, and to trigger the power-saving circuitry to return to the higher-power mode conditional on an user response to said prompt.

22. The television of claim 15, wherein the television screen is a High-Definition (HDTV) format screen.

23. A communication client application embodied on a computer-readable medium and comprising code for execution on a processing apparatus of a television, the code comprising:
first code configured so as when executed on the embedded processing apparatus to receive communication events via a network interface of the television to a packet-based network; and
second code configured so as when executed on the processing apparatus to issue power-control commands in order to control power-saving circuitry of the media appliance, and thereby to switch between: (i) a higher-power mode in which the screen is switched on, and (ii) a lower-power mode in which the screen is switched off, the lower-power mode being a mode set in response to a manual user input from a user input device;
wherein at least part of the first code is configured to continue executing on the processing apparatus during the lower-power mode, so as to monitor the network interface and thereby detect an incoming communication event, and in response to automatically trigger the power-saving circuitry to return to the higher-power mode so as to output a notification of the incoming communication event to the television screen prior to a manual response from said user.

24. A communication client application embodied on a computer-readable medium and comprising code for execution on a processing apparatus of a television, the code comprising:
first code configured so as when executed on the embedded processing apparatus to receive communication events via a network interface of the television to a packet-based network; and
second code configured so as when executed on the processing apparatus to issue power-control commands in order to control power-saving circuitry of the media appliance, and thereby to switch between: (i) a higher-power mode in which the screen is switched on, and (ii) a lower-power mode in which the screen is switched off and the processing apparatus is set to a lower-power processing state, the lower-power mode being a mode set in response to a manual user input from a user input device;
wherein at least part of the first code is configured to continue executing on the processing apparatus during the lower-power mode, so as to monitor the network interface for incoming communication events.

25. A method comprising:
executing a communication client application on an embedded processing apparatus of a television, the communication client being operable so as when executed to receive communication events via a network interface of the television to a packet-based network;
issuing power-control commands in order to control power-saving circuitry of the media appliance, and thereby to switch between: (i) a higher-power mode in which the screen is switched on, and (ii) a lower-power mode in which the screen is switched off, the lower-power mode being a mode set in response to a manual user input from a user input device; and
continuing to execute at least a part of the communication client application on the processing apparatus during the lower-power mode, so as to monitor the network interface and thereby detect an incoming communication event, and in response to automatically trigger the power-saving circuitry to return to the higher-power mode so as to output a notification of the incoming communication event to the television screen prior to a manual response from said user.

26. A method comprising:
executing a communication client application on an embedded processing apparatus of a television, the communication client being operable so as when executed to receive communication events via a network interface of the television to a packet-based network;
issuing power-control commands in order to control power-saving circuitry of the media appliance, and thereby to switch between: (i) a higher-power mode in which the screen is switched on, and (ii) a lower-power mode in which the screen is switched off and the processing apparatus is set to a lower-power processing state, the lower-power mode being a mode set in response to a manual user input from a user input device; and
continuing to execute the communication client application on the processing apparatus during the lower-power mode, so as to monitor the network interface for incoming communication events.
